(19) United States
(12) Patent Application Publication
(10) Pub. No.: US 2018/0051240 A1
(43) Pub. Date: Feb. 22, 2018

(54) FREQUENCY CONVERSION ULTRASONIC WINE AGING DEVICE

(71) Applicant: Wing Keung AU, Wanchai, Hong Kong (CN)

(72) Inventor: Wing Keung AU, Wanchai, Hong Kong (CN)

(21) Appl. No.: 15/557,692

(22) PCT Filed: Aug. 19, 2016
(86) PCT No.: PCT/CN2016/096093

§ 371 Date: Sep. 12, 2017

(30) Foreign Application Priority Data
Aug. 19, 2015 (CN) 201510512752.0

(51) Int. Cl. C12H 1/16

(52) U.S. Cl. CPC C12H 1/16

(57) ABSTRACT

A frequency conversion ultrasonic wine aging device for bottled wine comprises a base (1), and an opening portion formed by extending upwards along a peripheral edge of the base (2); a container is arranged in the opening portion and used for containing a sound conducting medium solution; when the frequency conversion ultrasonic wine aging device is used, a wine bottle (3) is placed in the container and immersed in the sound conducting medium solution; an ultrasonic transducer (21) and a control circuit board (23) are mounted in the base (2); the control circuit board (23) is provided thereon with an ultrasonic generating unit and an ultrasonic frequency modulation unit; the ultrasonic generating unit is used for converting a commercial power into an ultrasonic frequency alternating current signal; the ultrasonic frequency modulation unit serves to modulate the frequency of the ultrasonic frequency alternating current signal so that the frequency of the ultrasonic frequency alternating current signal varied cyclically within a set range; the frequency-modulated ultrasonic frequency alternating current signal is input into the ultrasonic transducer (21) to cause the ultrasonic transducer (21) to generate an ultrasonic wave; and the ultrasonic transducer (21) is used to transmit the ultrasonic wave into the container. The frequency conversion ultrasonic wine aging device can generate the best ultrasonic frequencies required for ripening and aging of various types of wines, and also realizes acceleration of a wine ripening process to achieve a quick aging effect.

### TECHNICAL FIELD

The present invention relates to the technical field of ultrasonic application, and in particular, to a frequency conversion ultrasonic wine aging device.

### BACKGROUND

Cavitation phenomenon induced by a high-power ultrasonic applied by an ultrasonic technology is considered as the most effective method of simulating varying wine which has an effect similar to that of a method of natural aging for multi years, and is confirmed to be able to effectively shorten the fermentation time, so the ultrasonic technology is used industrially to advance wine-making and ripening acceleration in the productive processes of fermentation and brewage, and has been used at scale. However, due to different features of various bottled wines, irradiated by industrial traditional ultrasonic of single frequency (20 KHz-40 KHz) may not successfully have good acceleratively ripening and aging effects on different kinds of wines.

### SUMMARY

The present invention provides a frequency conversion ultrasonic wine aging device to overcome the defect that the ultrasonic of single frequency adopted industrially cannot rapidly accelerate ripening or aging different types of bottled wines.

A frequency conversion ultrasonic wine aging device includes a base and an opening portion extending upward from a peripheral edge of the base, the opening portion is provided therein with a container for containing a sound conducting medium solution; when the frequency conversion ultrasonic wine aging device is used, a wine bottle is placed in the container and immersed in the sound conducting medium solution.

The base is equipped with an ultrasonic transducer and a control circuit board, the control circuit board is provided thereon with an ultrasonic generating unit and an ultrasonic frequency modulation unit.

The ultrasonic generating unit is used for converting a commercial power into an ultrasonic frequency alternating current (AC) signal.

The ultrasonic frequency modulation unit serves to modulate the frequency of the ultrasonic frequency AC signal, such that the frequency of the ultrasonic frequency AC signal varies cyclically within a set range; and frequency-modulated ultrasonic frequency AC signal is input into the ultrasonic transducer to cause the ultrasonic transducer to generate an ultrasonic wave.

The ultrasonic transducer is used to transmit the ultrasonic wave into the container.

Further, the control circuit board is further provided with an ultrasonic amplitude modulation unit; the ultrasonic amplitude modulation unit is used for modulating the amplitude of the frequency-modulated ultrasonic frequency AC signal with a commercial power signal, such that the amplitude of the ultrasonic frequency AC signal varies with a waveform of the commercial power signal, and then sending the amplitude-modulated ultrasonic frequency AC signal to the ultrasonic transducer to generate an ultrasonic wave.

Further, before the amplitude of the frequency-modulated ultrasonic frequency alternating current signal is modulated with the commercial power signal, the amplitude of the frequency-modulated ultrasonic frequency alternating current signal is pre-modulated by the ultrasonic amplitude modulation unit with a sine-wave signal with a frequency between the frequency of the commercial power signal and that of the ultrasonic frequency alternating current signal before frequency modulation, such that the amplitude of the frequency-modulated ultrasonic frequency alternating current signal varies with a waveform of the sine-wave signal.

Further, the set range is 25 KHz-35 KHz.

Further, a distance between the wine bottle and a vibration output end of the ultrasonic transducer is a quarter of the ultrasonic wave length.

Further, the vibration output end of the ultrasonic transducer is embedded at the bottom of the container, the frequency conversion ultrasonic wine aging device is provided with a bracket, the wine bottle is supported on the bracket without contacting the bottom of the container.

Further, a voltage top-top value of the ultrasonic frequency AC signal is 2 KVpp.

Further, the ultrasonic generating unit comprises a transformer for converting a commercial power voltage into a voltage of the ultrasonic frequency AC signal, and winding of the transformer is wound by silk-covered wires.

Further, the ultrasonic transducer transmits the ultrasonic wave into the container in an intermittent manner.

Compared with the prior art, the devices of the present invention modulates the frequency of the high-frequency ultrasonic frequency AC signal, such that the frequency varies cyclically within a set range, and then inputs the frequency-modulated ultrasonic frequency AC signal into the ultrasonic transducer so as to generate an ultrasonic signal with a frequency varying cyclically within the set range. The frequency conversion ultrasonic wine aging device can generate the best ultrasonic frequencies required for ripening and aging of various types of wines, and also realizes acceleration of a wine ripening process to achieve a quick aging effect. The devices of the present invention overcomes the defect that the ultrasonic of single frequency adopted industrially cannot rapidly accelerate ripening or aging different types of wines, so can rapidly accelerate ripening and aging different types of wines.

### BRIEF DESCRIPTION OF THE DRAWINGS

FIG. 1 is a structural schematic view of a base and an upper cover of a frequency conversion ultrasonic wine aging device provided by an embodiment of the present invention;

FIG. 2 is a structural schematic view of the frequency conversion ultrasonic wine aging device provided by the embodiment of the present invention with a wine bottle placed there in and covered by an upper cover;

FIG. 3 is a process schematic view of performing the amplitude pre-modulation on the frequency-modulated ultrasonic frequency AC signal with 1 KHz sine-wave signals;

FIG. 4 is a process schematic view of performing further amplitude modulation on the amplitude pre-modulated ultrasonic frequency AC signal with commercial power signals; and

FIG. 5 is an anatomical structural schematic view of the frequency conversion ultrasonic wine aging device provided by an embodiment of the present invention.

### DESCRIPTION OF THE EMBODIMENTS

In order to clarify the object, technical solution and advantages of the present invention to a greater extent, the present invention will be further explained in detail in conjunction to drawings and embodiments.

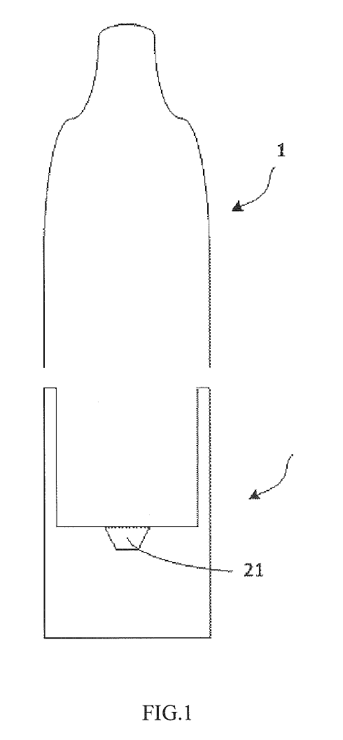

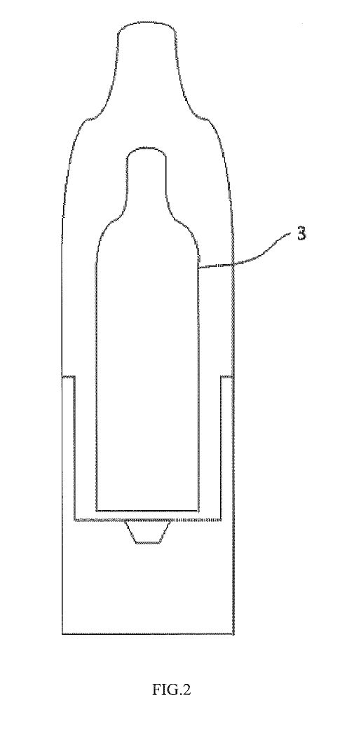

The present invention relates to a frequency conversion ultrasonic wine aging device which acceleratively ripens and ages wine by the cavitation effect of ultrasonic waves on liquid. Specifically, as shown in FIGS. 1 and 2, the frequency conversion ultrasonic wine aging device provided by the present invention includes a base 2, and an opening portion extending upward from a peripheral edge of the base 2, the opening portion is provided therein with a container for containing a sound conducting medium solution. In view of service environments of the present invention, water can be used as the sound conducting medium solution. When the frequency conversion ultrasonic wine aging device is used to acceleratively ripen and age the bottled wine, the wine bottle 3 is placed in the container and immersed in the sound conducting medium solution. The base 2 and its opening portion can be designed as integrally formed. In addition, an upper cover 1 can be further provided for detachably cap sealing on the opening portion. The upper cover 1 can be integrally formed, and generally, the upper cover 1 covers the opening portion of the base 2. The upper cover 1 and the base 2 cooperatively form an integral profile. The integral profile can be designed to have a shape similar to the shape of an ordinary wine bottle 3, as a high-class and aesthetic decoration. Since mechanical vibrations will be generated when the bottled wine in the container is acceleratively ripened and aged by using an ultrasonic wave, which causes noise, the upper cover 1 further has the effect of isolating the noise when the wine is acceleratively ripened and aged by using the frequency conversion ultrasonic wine aging device.

The base 2 is equipped therein with an ultrasonic transducer 21 and a control circuit board, the control circuit board is provided thereon with an ultrasonic generating unit and an ultrasonic frequency modulation unit. The ultrasonic generating unit is used for converting commercial power into an ultrasonic frequency AC signal. The ultrasonic frequency modulation unit is used to modulate the frequency of the ultrasonic frequency AC signal, such that the frequency of the ultrasonic frequency AC signal varies cyclically within a set range. The frequency-modulated ultrasonic frequency AC signal is input into the ultrasonic transducer 21 to cause the ultrasonic transducer 21 to generate an ultrasonic wave. The ultrasonic transducer 21 is used to transmit the ultrasonic wave into the container.

By means of the above frequency modulation manner, as long as the frequency range of the ultrasonic frequency AC signal is reasonably set, the generated ultrasonic wave can cover optimum ultrasonic frequencies required by acceleratively ripening and aging various kinds of wines, and can acceleratively ripen and age different types of wines. Experiments show that the ultrasonic within the frequency bands of 25 KHz to 35 KHz has significant cavitation effect on different types of wines, with the highest success rate of making wine liquid generate cavitation effect. Therefore, when the frequency modulation is performed on the ultrasonic frequency AC signal, the set range can be set as 25 KHz-35 KHz. By means of the frequency modulation, the frequency of the ultrasonic frequency AC signal varies cyclically within the range of 25 KHz to 35 KHz. Specifically, the frequency is increased or decreased by 1 KHz per 0.5 second; when reaching an either end of the range, the frequency returns to the other end by varying in a manner of increasing or decreasing by 1 KHz per 0.5 second. The ultrasonic transducer 21 transmits the ultrasonic wave into the container, for example, in an intermittent manner. That is, the transmission is alternated with pause, for example, keep transmitting for five minutes and then pausing for five seconds. Through the intermittent transmission, the ultrasonic transducer 21 is avoided to always work in a high-load working state, this contributes to prolong the service life of the ultrasonic transducer 21. Meanwhile, intermittent irradiation can prevent the liquid from generating a fixed standing wave due to a long-term irradiation, and thus improve the well-distributed mixing effect on the liquid by the whole vibration system. The frequency modulation process can be controlled by programming. In that case, a microcontroller can be arranged in the ultrasonic frequency modulation unit, to control the frequency modulation process by programming.

The control circuit board is further provided thereon with an ultrasonic amplitude modulation unit capable of modulating the amplitude of the frequency-modulated ultrasonic frequency AC signal with a commercial power signal, such that the amplitude varies with a waveform of the commercial power signal, and then the amplitude-modulated ultrasonic frequency AC signal is sent to the ultrasonic transducer 21 to generate the ultrasonic wave. The amplitude of the amplitude-modulated ultrasonic frequency AC signal varies with the waveform of the commercial power signal, which leads to the amplitude of the resultant ultrasonic waves also varying with the waveform of the commercial power signal, thereby avoid an ultrasonic oscillator always in a high output state. For example, the voltage top-top value of the ultrasonic frequency AC signal is 2 KVpp, after the amplitude of the ultrasonic frequency AC signal is modulated by a commercial power of 50/60 Hz, the amplitude of the ultrasonic frequency AC signal varies with the commercial power waveform, instead of being in the highest output state at each amplitude. In this way, although the time required by acceleratively ripening and aging wine may be increased, the service life of the ultrasonic transducer 21 can be prolonged significantly.

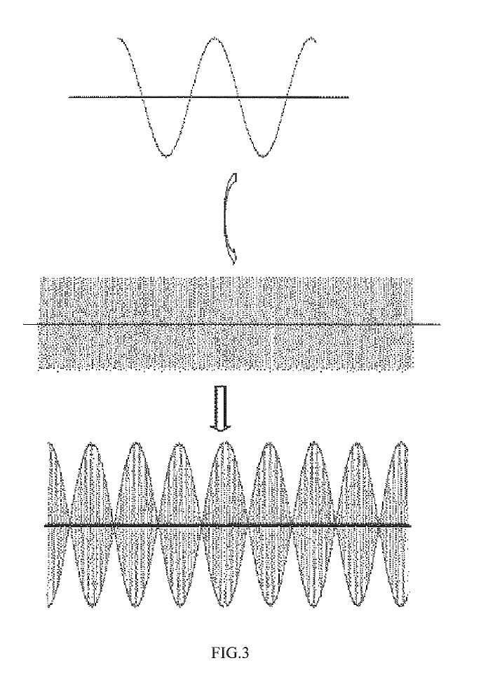

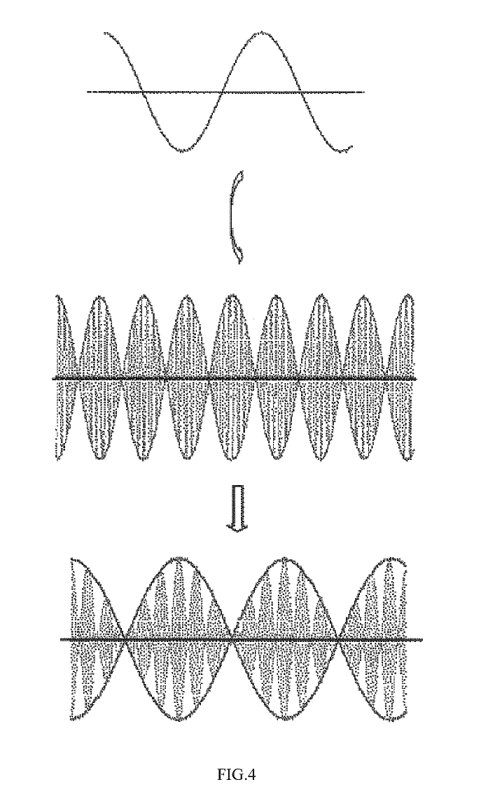

Before the amplitude of the frequency-modulated ultrasonic frequency AC signal is modulated with the commercial power signal by the ultrasonic amplitude modulation unit, the amplitude of the frequency-modulated ultrasonic frequency AC signal can be pre-modulated with a sine-wave signal with a frequency between the frequency of the commercial power signal and that of the ultrasonic frequency AC signal before frequency modulation, such that the amplitude of the frequency-modulated ultrasonic frequency AC signal varies with a waveform of the sine-wave signal. Similarly, the ultrasonic frequency AC signal with the voltage top-top value of 2 KVpp is taken as an example. As shown in FIG. 3, the amplitude of the ultrasonic frequency AC signal is pre-modulated with a sine-wave signal with a frequency of 1 KHz in advance, such that the amplitude of the ultrasonic frequency AC varies according to the waveform of the sine-wave signal. Then, as shown in FIG. 4, the amplitude of the amplitude pre-modulated ultrasonic frequency AC signal is further modulated with the commercial power signal. In FIG. 3, the three waveforms from top to bottom represent the 1 KHz sine-wave signal, the ultrasonic frequency AC signal with the frequency modulated by the ultrasonic frequency modulation unit, and the ultrasonic frequency AC signal with the amplitude pre-modulated by the 1 KHz sine-wave signal, respectively. In FIG. 4, the three waveforms from top to bottom represent the commercial power signal, the ultrasonic frequency AC signal with its amplitude pre-modulated with the 1 KHz sine-wave signal, and the ultrasonic frequency AC signal with its amplitude further modulated with the commercial power signal. The waveform of the ultrasonic frequency AC signal with its amplitude modulated with the commercial power signal in FIG. 4 shows that after two-time amplitude modulations (i.e., amplitude pre-modulation with 1 KHz sine-wave signal and amplitude modulation with the commercial power signal), the amplitude of the ultrasonic frequency AC signal is modulated to a greater extent. Compared to the signal without amplitude pre-modulation, the amplitude locates at the highest peak value or near the highest peak value in less time, thereby reducing the time of the ultrasonic transducer 21 in a high output state, which further protects the ultrasonic transducer 21 and prolongs its service life.

The ultrasonic frequency AC signal generated by cyclically varying the frequency and twice amplitude modulation in the above combines the frequency conversion and amplitude repeatability, and generates an ultrasonic wave with an impulsive effect after being converted into the ultrasonic wave by the ultrasonic transducer 21. Then, the ultrasonic wave is transmitted in the intermittent manner, to create a multi-mode mechanical vibration of ringing, relaxing and adjusting, such that a sufficient mixture is achieved in the vibration system and the ongoing cavitation effect is distributed more evenly.

According to the same principle as the radio wave, it is assumed that the wavelength of the ultrasonic wave is λ, and the distance between the vibration output end of the ultrasonic transducer 21 and the wine bottle 3 is d. When

d=(₄¹λ)×2ⁿ, (n==0,1,2) [equation 1],

the optimum ultrasonic energy transfer efficiency is obtained. When the distance

d=₄¹λ [equation 2],

there is the lowest requirement for the space, whereas when

d=λ [equation 3],

there is the highest requirement for the space. Therefore, in the present invention, the distance between the wine bottle 3 and the vibration output end of the ultrasonic transducer 21 is set to be a quarter (one fourth) of the ultrasonic wave length.

In order to ensure good conduction for the ultrasonic wave, the ultrasonic transducer 21 is installed at the bottom of the container, and the vibration output end of the ultrasonic transducer 21 is embedded at the bottom of the container. However, in this case, if the wine bottle 3 is directly placed in the container, a weight of the wine bottle 3 is directly exerted on the container. In this way, when the ultrasonic acceleratively ripening and aging are performed, due to the mechanical vibration generated by the ultrasonic transducer 21, the wine bottle 3 would slightly move as a result of the mechanical vibration of the ultrasonic transducer 21. Such movement causes the friction between the wine bottle 3 and the container to generate noise. Besides, the wine bottle 3 directly contacting the bottom of the container results in the wine bottle 3 directly pressing a vibration output surface of the ultrasonic transducer 21, which leads to a resonant frequency offset of the wine, thereby reducing the acceleratively ripening and aging efficiency a lot. Therefore, in the present invention, the frequency conversion ultrasonic wine aging device is provided thereon with a bracket, and the wine bottle 3 is supported on the bracket without contacting the bottom of the container directly, thereby avoiding that problem.

In order to be adapted to various voltage standards in different countries, the control circuit board is provided thereon with an international voltage converting unit for identifying the commercial power voltage, and converting the commercial power voltage into a working voltage of the ultrasonic generating unit, and the transmitting the working voltage to the ultrasonic generating unit.

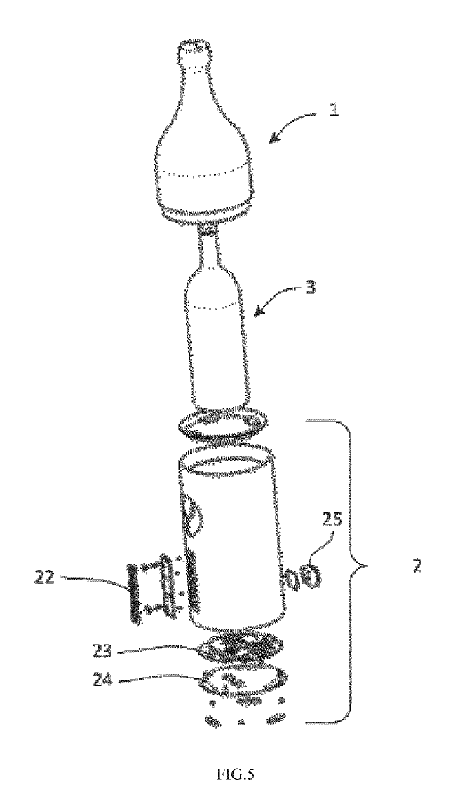

FIG. 5 is an anatomical structural schematic view of the ultrasonic conversion wine aging device provided by an embodiment of the present invention. The control circuit board 23 is fixedly mounted at the bottom of the base 2 by a bracket, and the bottom of the base 2 is sealed by a metal plate 24. A side wall of the base 2 is further provided thereon with an operation panel 22 and a power supply input socket 25 which are opposite to each other in position.

In order to generate ultrasonic waves having enough intensity to acceleratively ripen and age the wine, it is necessary for the ultrasonic generating unit to generate an ultrasonic frequency AC signal having enough intensity. In the present invention, the commercial power (for example, 110V or 220V) is converted into the ultrasonic frequency AC signal with a peak value which may reach 2 KVpp, and the signal is applied to the ultrasonic transducer 21 to generate an ultrasonic wave having enough intensity. The ultrasonic generating unit includes a transformer for converting the commercial power voltage into the voltage of the ultrasonic frequency AC signal. Such a high multiple of voltage conversion may overheat the transformer, which influences the stability and the service life of the transformer. Therefore, the windings of the transformer are wound by silk-covered wires, thereby significantly reducing the temperature of the transformer, which ensures the working stability of the transformer. Meanwhile, the housing and the container of the frequency conversion ultrasonic wine aging device are preferably made of stainless steel, the super strong heat-conducting performance of which provides terrific heat dissipating effect for the present frequency conversion ultrasonic wine aging device. Moreover, in operation, since the temperature of the transformer, which is the main heat generating component, is controlled by the silk-covered wire, thus the frequency conversion ultrasonic wine aging device can operable at a relatively low working temperature for a long time without a cooling fan, thereby significantly reducing a noise caused by the cooling fan. Accordingly, a ventilation opening is avoided, which avoids an inside of the frequency conversion ultrasonic wine aging device being affected by dust and so on, and also gives consideration to aesthetics. The portion between an inner wall of the opening portion and an outer wall of the container is vacant, which can isolate the vibration noise.

The control circuit board is further provided thereon with a safety protection unit including at least one of an electric leakage APO (automatic power off) protection circuit, a pouring APO protection circuit, an over-temperature APO protection circuit and an over-current APO protection circuit. When an electric leakage is detected by the electric leakage APO protection circuit, or an inclination of the frequency conversion ultrasonic wine aging device is detected by the pouring APO protection circuit, the power supply of the frequency conversion ultrasonic wine aging device can be automatically cut off, which plays a role of safety protection. Similarly, when over temperature or over current of the frequency conversion ultrasonic wine aging device is detected by the over-temperature APO protection circuit, or over current of the frequency conversion ultrasonic wine aging device is detected by the over-current APO protection circuit, the power supply of the frequency conversion ultrasonic wine aging device can also be automatically cut off, which plays a role of safety protection.

The foregoing is only the preferable embodiment of the present invention, and is not used for limiting the present invention. Any modification, equivalent substitution and improvement made within the spirit and principle of the present invention shall fall within the protection scope of the present invention.

1. A frequency conversion ultrasonic wine aging device, comprising a base and an opening portion extending upward from a peripheral edge of the base; the opening portion is provided with a container for containing a sound conducting medium solution, when the frequency conversion ultrasonic wine aging device is used, a wine bottle is placed in the container and immersed in the sound conducting medium solution, wherein
the base is equipped with an ultrasonic transducer and a control circuit board; the control circuit board is provided thereon with an ultrasonic generating unit and an ultrasonic frequency modulation unit,
the ultrasonic generating unit is used for converting commercial power into an ultrasonic frequency alternating current signal,
the ultrasonic frequency modulating unit is used for modulating a frequency of the ultrasonic frequency alternating current signal, such that the frequency of the ultrasonic frequency varies cyclically within a set range, and the frequency-modulated ultrasonic frequency alternating current signal is input into the ultrasonic transducer so as to generate an ultrasonic wave,
the ultrasonic transducer is used for transmitting the ultrasonic wave into the container.

2. The frequency conversion ultrasonic wine aging device according to claim 1, wherein the control circuit board is further provided with an ultrasonic amplitude modulation unit; the ultrasonic amplitude modulation unit is used for modulating the amplitude of the frequency-modulated ultrasonic frequency alternating current signal with a commercial power signal, such that the amplitude of the ultrasonic frequency alternating current signal varies with a waveform of the commercial power signal, and then for sending the amplitude-modulated ultrasonic frequency alternating current signal to the ultrasonic transducer to generate an ultrasonic wave.

3. The frequency conversion ultrasonic wine aging device according to claim 2, wherein before the amplitude of the frequency-modulated ultrasonic frequency alternating current signal is modulated with the commercial power signal, the amplitude of the frequency-modulated ultrasonic frequency alternating current signal is pre-modulated by the ultrasonic amplitude modulation unit with a sine-wave signal with a frequency between the frequency of the commercial power signal and that of the ultrasonic frequency alternating current signal before frequency modulation, such that the amplitude of the frequency-modulated ultrasonic frequency alternating current signal varies with a waveform of the sine-wave signal.

4. The frequency conversion ultrasonic wine aging device according to claim 1, wherein the set range is 25 KHz-35 KHz.

5. The frequency conversion ultrasonic wine aging device according to claim 1, wherein the distance between the wine bottle and a vibration output end of the ultrasonic transducer is a quarter of the ultrasonic wave length.

6. The frequency conversion ultrasonic wine aging device according to claim 1, wherein the vibration output end of the ultrasonic transducer is embedded at the bottom of the container, the frequency conversion ultrasonic wine aging device is provided with a bracket, the wine bottle is supported on the bracket without contacting the bottom of the container.

7. The frequency conversion ultrasonic wine aging device according to claim 1, wherein a voltage top-top value of the ultrasonic frequency AC electrical signal is 2 KVpp.

8. The frequency conversion ultrasonic wine aging device according to claim 1, wherein the ultrasonic generating unit comprises a transformer for converting a commercial power voltage into a voltage of the ultrasonic frequency AC electrical signal, and windings of the transformer is wound by silk-covered wires.

9. The frequency conversion ultrasonic wine aging device according to claim 1, wherein the ultrasonic transducer transmits the ultrasonic wave into the container in an intermittent manner.
